(19) United States
(12) Patent Application Publication
(10) Pub. No.: US 2019/0258875 A1
(43) Pub. Date: Aug. 22, 2019

(54) DRIVING ASSIST SYSTEM WITH VEHICLE TO VEHICLE COMMUNICATION

(71) Applicant: Magna Electronics Inc., Auburn Hills, MI (US)

(72) Inventor: Oscar Flores-Bamaca, Macomb, MI (US)

(21) Appl. No.: 16/275,398

(22) Filed: Feb. 14, 2019

Related U.S. Application Data
(60) Provisional application No. 62/631,697, filed on Feb. 17, 2018.

(51) Int. Cl. G06K 9/00; H04W 4/46

(52) U.S. Cl. CPC G06K 9/00791; H04N 5/2253; G06K 2209/15; H04W 4/46

(57) ABSTRACT

A vehicular driving assist system includes a camera disposed at an equipped vehicle, a wireless communication module operable to wirelessly communicate with other vehicles near the equipped vehicle, and a control that wirelessly communicates with other vehicles via the wireless communication module. The control wirelessly receives license plate information from another vehicle. The control, via processing of image data captured by the camera, determines license plate information of another vehicle. The control determines if the license plate information received wirelessly and the determined license plate information match. Responsive to determination that the wirelessly received license plate information and the determined license plate information match, the control establishes a secure communication channel with the other vehicle. When the wirelessly received license plate information and the determined license plate information do not match, the control does not establish a secure communication channel with the other vehicle.

### CROSS REFERENCE TO RELATED APPLICATION

The present application claims the filing benefits of U.S. provisional application Ser. No. 62/631,697, filed Feb. 17, 2018, which is hereby incorporated herein by reference in its entirety.

### FIELD OF THE INVENTION

The present invention relates generally to a driving assist system for a vehicle and, more particularly, to a driving assist system that utilizes vehicle to vehicle communication.

### BACKGROUND OF THE INVENTION

Communication between vehicles is known. Examples of such vehicle to vehicle or V2V communication systems are described in U.S. Pat. Nos. 6,690,268; 9,036,026 and/or 9,126,525, which are hereby incorporated herein by reference in their entireties.

### SUMMARY OF THE INVENTION

The present invention provides a driving assistance system or vision system or imaging system for a vehicle that utilizes one or more cameras (preferably one or more CMOS cameras) to capture image data representative of images exterior of the vehicle, and includes a wireless communication module to wirelessly communicate with other vehicles near the vehicle. The system also includes a control that includes an image processor to process image data from the cameras and communicates with nearby vehicles via the wireless communication module. Responsive to proximity to another vehicle, the vehicle receives the other vehicle's license plate information (or vehicle identification information) via wireless communication. The vehicle also visually determines the other vehicle's license plate information via the cameras. For example, the other vehicle may be a leading vehicle ahead of the equipped vehicle and a forward viewing camera of the equipped vehicle may capture image data representative of a rear portion of the leading vehicle that includes the leading vehicle's license plate. The control determines if the license plate information (or vehicle identification information) obtained via wireless communication and license plate information obtained via the camera (via processing of image data captured by the camera) match. Responsive to determination of a match, the vehicle or control system establishes a secure communication channel with a system of the second or leading vehicle (such as with a communication system or control system of the second or leading vehicle). Responsive to failing to match the license plate information, the vehicle does not establish a secure communications channel.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a driver assistance system that incorporates cameras in accordance with the present invention;

FIG. 2 is a plan view of a head vehicle and a tail vehicle in accordance with the present invention;

FIG. 3 is a plan view of a daisy chain of vehicles in accordance with the present invention;

FIG. 4 is a plan view of collision avoidance in accordance with the present invention; and

FIG. 5 is another plan view of a daisy chain of vehicles in accordance with the present invention.

### DESCRIPTION OF THE PREFERRED EMBODIMENTS

A vehicle vision system and/or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

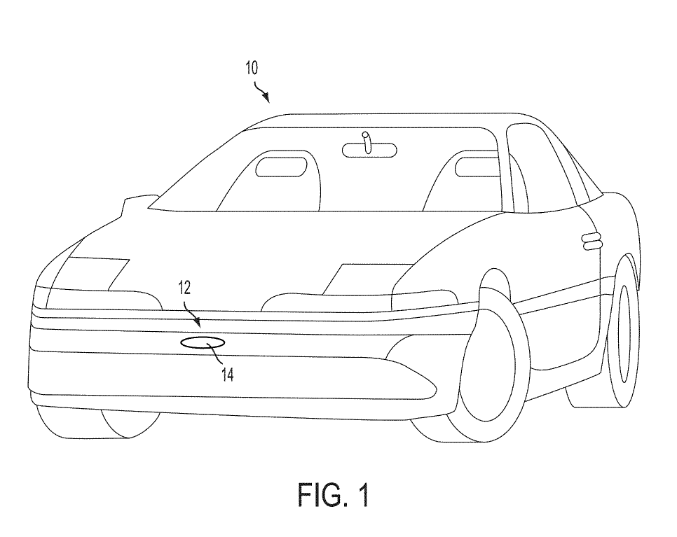

Referring now to the drawings and the illustrative embodiments depicted therein, a vehicle 10 includes an imaging system or vision system 12 that includes at least one exterior viewing imaging sensor or camera, such as a forward viewing camera 14 at the front (or at the windshield) of the vehicle, which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor that is operable to process image data captured by the camera or cameras and may detect objects or the like and/or provide displayed images at a display device for viewing by the driver of the vehicle. The data transfer or signal communication from the camera to the ECU may comprise any suitable data or communication link, such as a vehicle network bus or the like of the equipped vehicle.

For autonomous vehicles suitable for deployment with the system of the present invention, an occupant of the vehicle may, under particular circumstances, be desired or required to take over operation/control of the vehicle and drive the vehicle so as to avoid potential hazard for as long as the autonomous system relinquishes such control or driving. Such occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically, an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x or V2I (vehicle to infrastructure) communication system.

In accordance with the present invention, by using enhancements of wireless technology (such as the wireless technology standard BLUETOOTH® 5.0 or other short range wireless communication protocol) with advanced driving assistance systems (ADAS), secure and reliable connections can be established between systems of multiple vehicles in a daisy chain configuration. This provides opportunities to improve safety on the road by allowing vehicles in the daisy chain to respond to traffic and weather conditions in advance without having to have a visual on the actual condition. This also improves performance of autonomous vehicles by allowing them to react to “future” conditions (ahead of a subject vehicle and not yet encountered by the subject vehicle).

BLUETOOTH® 5.0 provides bandwidth up to 2 Mbps. By doubling the amount of data that devices can transfer over previous versions, BLUETOOTH® 5.0 reduces the time required for transmitting and receiving data, facilitating rapid and reliable over-the-air communications.

Additionally, more efficient use of broadcasting channels on the increasingly crowded 2.4 GHz band, with less broadcast time required for completion of tasks, provides for richer connectionless and beacon-based BLUETOOTH® solutions.

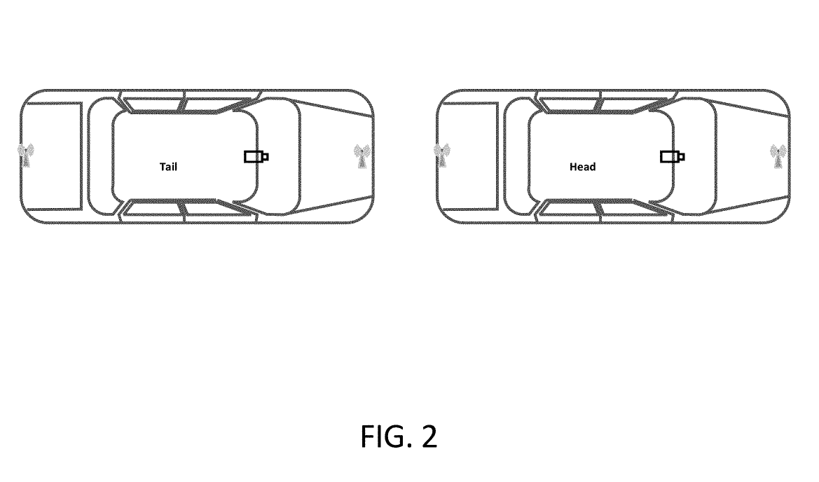

ADAS capabilities enable an identification of a vehicle (a head vehicle or leading vehicle) in front of a subject or equipped vehicle (or tail vehicle or following or trailing vehicle), by detecting vehicle license plate information (such as a vehicle plate number). The head or leading vehicle transmits (or “beacons”), such as via BLUETOOTH®, the license plate information to the vehicle (tailing or following vehicle) behind the head or leading vehicle (see FIG. 2). The license plate information is received by the following or trailing vehicle if the following or trailing vehicle is within the communication range of the leading vehicle (such as following the leading vehicle within a threshold distance behind the leading vehicle). The system of the following vehicle compares license plate information determined via processing image data received through a front camera of the following vehicle with the license plate information received from the leading vehicle via the short range wireless communication (such as via BLUETOOTH® communication or the like). If the wirelessly received license plate information matches the imaged and determined license plate information (and thus represent the same other or leading vehicle ahead of the equipped vehicle), the system of the trailing or equipped vehicle enables a secure wireless connection with the leading vehicle.

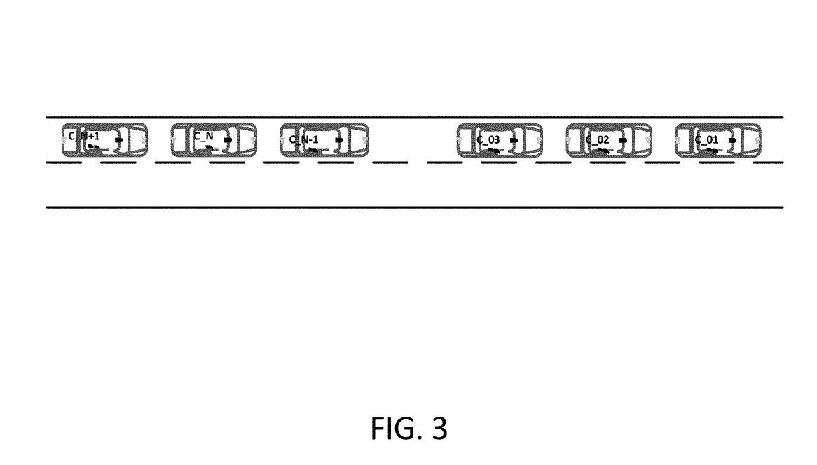

The connection is a point-to-point connection between the leading vehicle and the trailing vehicle in order to keep a secure connection. However, in a multiple vehicle connection (more than 2 vehicles that are similarly equipped with a communication system and control), the N position vehicle validates the information from the N−1 position vehicle, and the N+1 position vehicle validates the information from the N position vehicle, so the N+1 position vehicle can trust the information that the N vehicle is telling about the N−1 vehicle. This sequence may be repeated multiple times to form a daisy chain of multiple similarly equipped vehicles traveling along a traffic lane of a road (see FIG. 3). Thus, each vehicle is in communication with a system of the immediately preceding vehicle (and the immediately following vehicle) and, after the secure connections are established along the line or chain of vehicles (and between adjacent or consecutive vehicles), information about the driving conditions ahead of the leading vehicle can be communicated along the chain of following vehicles via the secure connections, so that the control or system of each following vehicle is aware of the driving conditions (such as a hazardous condition or the like) ahead of the leading vehicle in the chain or line of vehicles traveling along the same traffic lane of the road. The system provides for such communications and provides for a secure, reliable communication chain so that the systems of the trailing vehicles can rely on the provided information as being representative of the driving conditions ahead of the equipped vehicle (and not from another vehicle in a different traffic lane or on a different road than the lane and road being traveled by the equipped vehicle).

In the vehicle's Controller Area Network (CAN) bus, multiple signals are being broadcast. For example, signals for yaw rate, vehicle speed, wiper speed, and steering wheel angle may all be present on the CAN bus. The front camera may provide a variety of additional information. For example, the vehicle system and/or the front camera may determine or provide a free lane signal, an update counter for objects and lane markings, and/or classification of a detected object, and/or the like.

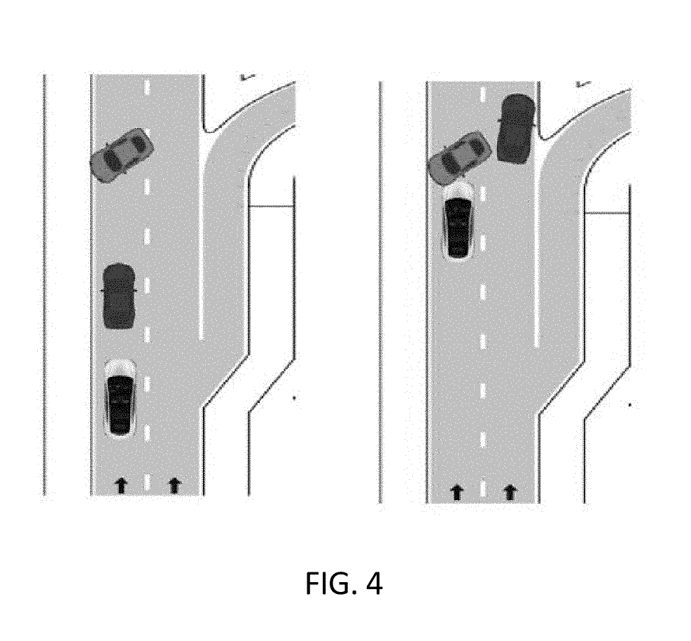

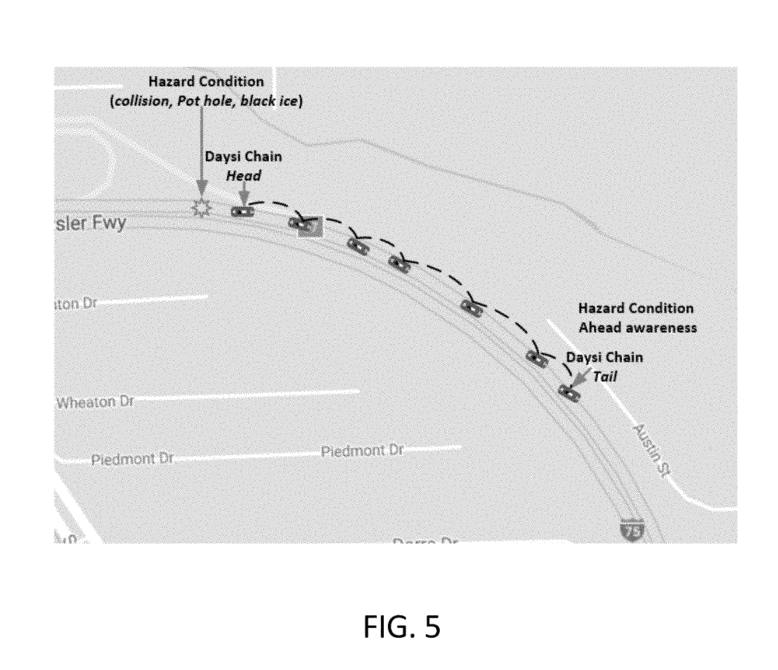

This information, when received via the secure communication connection by the trailing vehicle(s), allows the trailing vehicle to determine the conditions of the road ahead without having a visually experiencing such conditions. This will enable to the ADAS system of the equipped trailing vehicle (or vehicles) to avoid and/or prepare for these conditions rather than react as the vehicle(s) arrives at those conditions or situations, which improves the safety of the drivers and/or occupants of the trailing vehicles (see FIGS. 4 and 5).

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

The system may also communicate with other systems through communication protocols other than BLUETOOTH®. For example, car2X or V2X or V2I (vehicle to infrastructure) or a 4G or 5G broadband cellular network technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The system may utilize sensors, such as radar or lidar sensors or the like. The sensing system may utilize aspects of the systems described in U.S. Pat. Nos. 9,753,121; 9,689,967; 9,599,702; 9,575,160; 9,146,898; 9,036,026; 8,027,029; 8,013,780; 6,825,455; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication Nos. WO 2018/007995 and/or WO 2011/090484, and/or U.S. Publication Nos. US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A driving assist system for a vehicle, said driving assist system comprising:
a camera disposed at a vehicle equipped with said driving assist system and having a field of view exterior of the equipped vehicle;
a wireless communication module disposed at the equipped vehicle and operable to wirelessly communicate with other vehicles near the equipped vehicle;
a control disposed at the equipped vehicle and comprising an image processor for processing image data captured by the camera, wherein the control communicates with the other vehicles via the wireless communication module;
wherein the control receives license plate information from another vehicle via wireless communication;
wherein the control, via image processing by the image processor of image data captured by the camera, determines license plate information of another vehicle in the field of view of the camera;
wherein the control determines if the wirelessly received license plate information and the determined license plate information match and are representative of the same other vehicle;
wherein the control, responsive to determination that the wirelessly received license plate information and the determined license plate information match, establishes a secure wireless communication channel with a system of the other vehicle; and
wherein the control, responsive to determination that the wirelessly received license plate information and the determined license plate information do not match, does not establish a secure communication channel with the system of the other vehicle.

2. The driving assist system of claim 1, wherein the wireless communication module comprises a short range wireless communication module.

3. The driving assist system of claim 1, wherein the wireless communication module comprises a BLUETOOTH® module.

4. The driving assist system of claim 1, wherein the control transmits license plate information of the equipped vehicle to other vehicles near the equipped vehicle.

5. The driving assist system of claim 1, wherein the control, responsive to determination of a trailing vehicle being behind the equipped vehicle, transmits license plate information of the equipped vehicle to the trailing vehicle.

6. The driving assist system of claim 1, wherein the camera is disposed at the equipped vehicle so as to have its field of view forward of the equipped vehicle.

7. The driving assist system of claim 1, wherein the camera is disposed at an in-cabin surface of a windshield of the equipped vehicle so as to have its field of view through the windshield and forward of the equipped vehicle.

8. The driving assist system of claim 1, wherein, with the secure communication channel established with the other vehicle, the control wirelessly receives information pertaining to a driving condition ahead of the other vehicle and outside of the field of view of the camera of the equipped vehicle.

9. The driving assist system of claim 8, wherein the wirelessly received information pertaining to the driving condition ahead of the other vehicle comprises information pertaining to a hazardous condition along a road being traveled by the equipped vehicle and the other vehicle ahead of the equipped vehicle.

10. The driving assist system of claim 8, wherein the control, responsive to determination of a trailing vehicle being behind the equipped vehicle, transmits license plate information of the equipped vehicle to the trailing vehicle, and wherein, responsive to a secure communication channel being established with a system of the trailing vehicle, the control wirelessly communicates the information pertaining to the driving condition ahead of the other vehicle to the system of the trailing vehicle.

11. A driving assist system for a vehicle, said driving assist system comprising:
a camera disposed at a vehicle equipped with said driving assist system and having a field of view exterior and forward of the equipped vehicle;
a wireless communication module disposed at the equipped vehicle and operable to wirelessly communicate with other vehicles near the equipped vehicle;
a control disposed at the equipped vehicle and comprising an image processor for processing image data captured by the camera, wherein the control communicates with the other vehicles via the wireless communication module;
wherein the control receives license plate information from another vehicle via wireless communication;
wherein the control, via image processing by the image processor of image data captured by the camera, determines license plate information of another vehicle ahead of the equipped vehicle and in the field of view of the camera;
wherein the control determines if the wirelessly received license plate information and the determined license plate information match and are representative of the same other vehicle;
wherein the control, responsive to determination that the wirelessly received license plate information and the determined license plate information match, establishes a secure wireless communication channel with a system of the other vehicle;
wherein, with the secure communication channel established with the other vehicle, the control wirelessly receives information pertaining to a driving condition ahead of the other vehicle and outside of the field of view of the camera of the equipped vehicle; and
wherein the control, responsive to determination that the wirelessly received license plate information and the determined license plate information do not match, does not establish a secure communication channel with the system of the other vehicle.

12. The driving assist system of claim 11, wherein the control transmits license plate information of the equipped vehicle to other vehicles near the equipped vehicle.

13. The driving assist system of claim 11, wherein the camera is disposed at an in-cabin surface of a windshield of the equipped vehicle so as to have its field of view through the windshield and forward of the equipped vehicle.

14. The driving assist system of claim 11, wherein the wirelessly received information pertaining to the driving condition ahead of the other vehicle comprises information pertaining to a hazardous condition along a road being traveled by the equipped vehicle and the other vehicle ahead of the equipped vehicle.

15. The driving assist system of claim 11, wherein the control, responsive to determination of a trailing vehicle being behind the equipped vehicle, transmits license plate information of the equipped vehicle to the trailing vehicle, and wherein, responsive to a secure communication channel being established with a system of the trailing vehicle, the control wirelessly communicates the information pertaining to the driving condition ahead of the other vehicle to the system of the trailing vehicle.

16. A driving assist system for a vehicle, said driving assist system comprising:
a camera disposed at a vehicle equipped with said driving assist system and having a field of view exterior and forward of the equipped vehicle;
a wireless communication module disposed at the equipped vehicle and operable to wirelessly communicate with other vehicles near the equipped vehicle;
a control disposed at the equipped vehicle and comprising an image processor for processing image data captured by the camera, wherein the control communicates with the other vehicles via the wireless communication module;
wherein the control receives license plate information from another vehicle via wireless communication;
wherein the control, via image processing by the image processor of image data captured by the camera, determines license plate information of a leading vehicle ahead of the equipped vehicle and in the field of view of the camera;
wherein the control determines if the wirelessly received license plate information from the other vehicle and the determined license plate information match of the leading vehicle and are representative of the same vehicle;
wherein the control, responsive to determination that the wirelessly received license plate information and the determined license plate information match, establishes a secure wireless communication channel with a system of the leading vehicle;
wherein, with the secure communication channel established with the system of the leading vehicle, the control wirelessly receives information pertaining to a driving condition ahead of the leading vehicle and outside of the field of view of the camera of the equipped vehicle;
wherein the control transmits license plate information of the equipped vehicle to other vehicles near the equipped vehicle for use in establishing a secure communication channel with a system of a trailing vehicle that is following the equipped vehicle; and
wherein, responsive to the secure communication channel being established with the system of the trailing vehicle, the control wirelessly communicates the information pertaining to the driving condition ahead of the leading vehicle to the system of the trailing vehicle.

17. The driving assist system of claim 16, wherein the wireless communication module comprises a BLUETOOTH® module.

18. The driving assist system of claim 17, wherein the control, responsive to determination that the wirelessly received license plate information and the determined license plate information do not match, does not establish a secure communication channel with the leading vehicle.

19. The driving assist system of claim 16, wherein the camera is disposed at an in-cabin surface of a windshield of the equipped vehicle so as to have its field of view through the windshield and forward of the equipped vehicle.

20. The driving assist system of claim 16, wherein the wirelessly received information pertaining to the driving condition ahead of the leading vehicle comprises information pertaining to a hazardous condition along a road being traveled by the equipped vehicle and the leading vehicle ahead of the equipped vehicle.
